(19) United States
(12) Patent Application Publication
(10) Pub. No.: US 2018/0288373 A1
(43) Pub. Date: Oct. 4, 2018

(54) TREATMENT METHOD FOR DOORBELL COMMUNICATION

(71) Applicant: National Taipei University of Technology, Taipei City (TW)

(72) Inventors: Shaw Hwa HWANG, Taipei City (TW); Bing Chih YAO, Taipei City (TW); Kuan Lin CHEN, Taipei City (TW); Yao Hsing CHUNG, Taipei City (TW); Chi Jung HUANG, Taipei City (TW); Cheng Yu YEH, Taipei City (TW); Shun Chieh CHANG, Taipei City (TW); Li Te SHEN, Taipei City (TW); Ning Yun KU, Taipei City (TW); Tzu Hung LIN, Taipei City (TW); Ming Che YEH, Taipei City (TW)

(21) Appl. No.: 15/473,669

(22) Filed: Mar. 30, 2017

(51) Int. Cl. H04N 7/18; G06K 9/00

(52) U.S. Cl. CPC H04N 7/186; G06K 9/00255; G06K 9/00926; G06K 9/00295

(57) ABSTRACT

The present invention provides a treatment method for doorbell communication in order to save the data bandwidth of video streaming communication. The structure of doorbell communication according to the present invention comprises a doorbell, a camera and a microphone, which are connected with a smart phone and a server of a home by a network. When a user pushes the doorbell, the camera captures the face image of the user, and then sends to the server for face recognition. If the face image of the user matches with one of the face templates stored in the server, then the personal data of the related face template is shown on the screen of the smart phone for conducting audio streaming communication without video streaming communication.

### FIELD OF THE INVENTION

The present invention relates to a treatment method for doorbell communication, and more particularly to a doorbell communication method of employing audio streaming without video streaming for acquaintance.

### BACKGROUND OF THE INVENTION

Referring to FIG. 1, which is a schematic diagram for conventional doorbell communication. When the user A pushes the doorbell 1, the camera 2 captures the face image of the user A for sending to the screen 3 in the home. A person of the home can see the face image of the user A through the screen 3 and the user A uses the microphone 4 to speak to the person of the home.

OmniVision Technologies has a doorbell product which can send the face image of the user A directly to a smart phone of the person of the home through a Wi-Fi network in the home, so that the person of the home can sec the user A directly through the smart phone. But this kind of video streaming communication employs too much data bandwidth. If the user A is an acquaintance, then this kind of video streaming communication is unnecessary.

### SUMMARY OF THE INVENTION

The object of the present invention is to provide a treatment method for doorbell communication, in order to save the data bandwidth of video streaming communication.

The structure of the doorbell communication according to the sent invention comprises a doorbell, a camera and a microphone, connected with a smart phone and a server of a home by a network.

When a user pushes the doorbell, the camera captures a face image of the user for sending through the network to the server for conducting a face identifying operation. If the face identifying operation is not successful, then a person of the home uses the smart phone for conducting audio and video streaming communication with the user, and decide whether to open door or not, generally not open the door, and stop the audio and video streaming communication.

If the face identifying operation is successful, then form a face template of the user and compare with face templates of acquaintances in the server. If there is no match, then the person of the home conducts audio and video streaming communication with the user by thee smart phone.

As the audio and video streaming communication is ended, prompt the person of the home whether to store the face template of the user in the server or not, if the person of the home agrees, then prompt the person of the home to input personal data of the user, and the face template and the personal data of the user are stored in the server; if the person of the home disagrees to store the face template of the user, then go for ending.

If a face template in the server matches with the face template of the user, then a personal data of the matched face template in the server is shown on the screen of the smart phone, the person of the home uses the smart phone for conducting audio streaming communication with the user, without video streaming communication.

Face templates of acquaintances in the server can be obtained by other ways, and then input related personal data, conduct the face identifying operation. If the face identifying operation is successful, then the face template and the personal data are stored in the server.

### BRIEF DESCRIPTION OF THE DRAWINGS

FIG. 1 shows schematically a diagram for conventional doorbell communication.

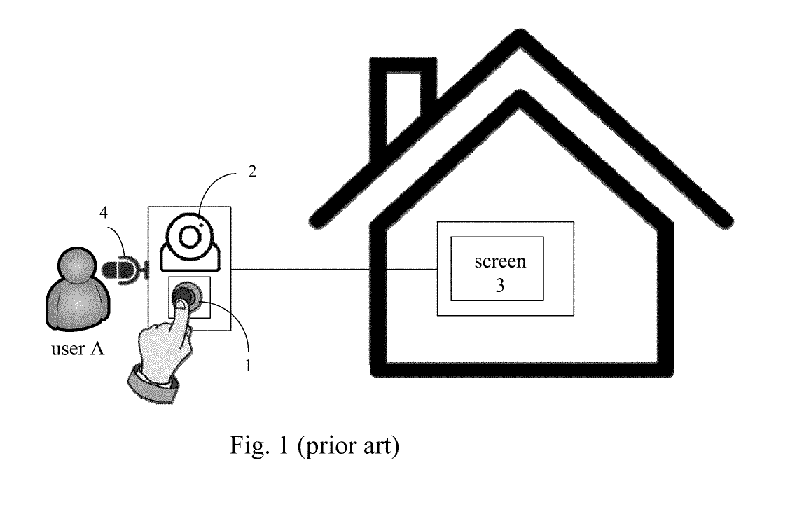

FIG. 2 shows schematically the structure of a doorbell communication according to the present invention.

FIG. 3 shows schematically the face identifying operation according to the present invention.

FIG. 4 shows schematically that there are other ways to select a picture of the acquaintance.

FIG. 5 shows schematically that the face templates in the server are used for comparing with the face image of a user.

FIG. 6 shows schematically the flow chart of the software program for the treatment method of doorbell communication according to the present invention

### DETAILED DESCRIPTIONS OF THE PREFERRED EMBODIMENTS

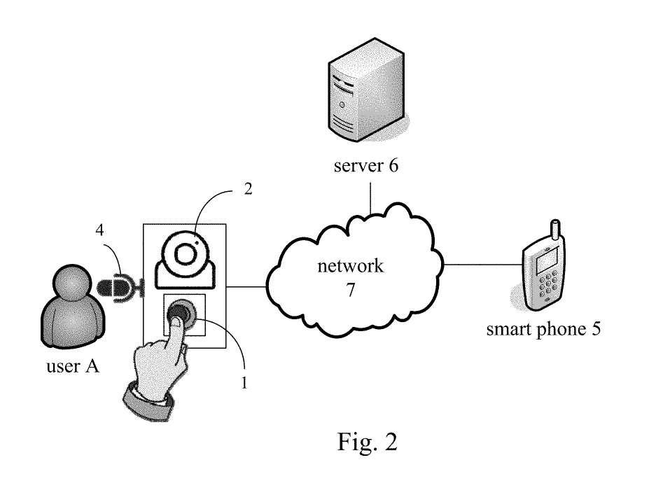

Referring to FIG. 2 which shows schematically the structure of a doorbell communication according to the present invention. After the user A pushes the doorbell 1, the camera 2 captures the face image of the user A for sending through the network 7 to the smart phone 5 of the person of the home (the person of the home may be at outside of the home). The person of the home can see the face image of the user A through the screen of the smart phone 5, and the user A uses the microphone 4 to speak with the person of the home by the smart phone 5.

A server 6 is added in the present invention, as shown in FIG. 2. The server 6 may be at home or at outside of the home. The related software program according to the present invention is stored in the server 6 for processing the face image of the user A and generating the corresponding actions as described below.

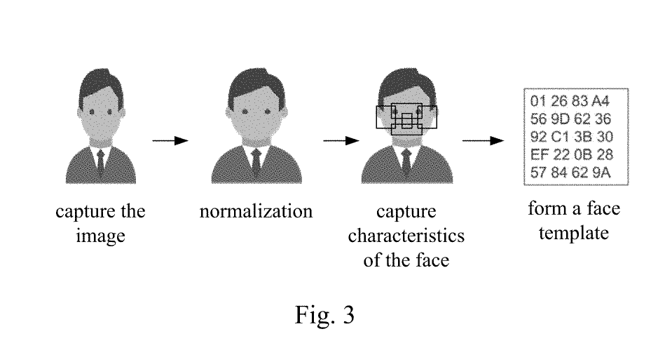

Referring to FIG. 3, the camera 2 captures the face image of the user A with four steps:

1. Capture the image

2. Normalization: to adjust the position and magnitude of the face

3. Capture characteristics of the face

4. Form a face template, as shown in FIG. 3.

If the face identifying operation is successful, then the face template of the user A is stored in a data base of the server 6.

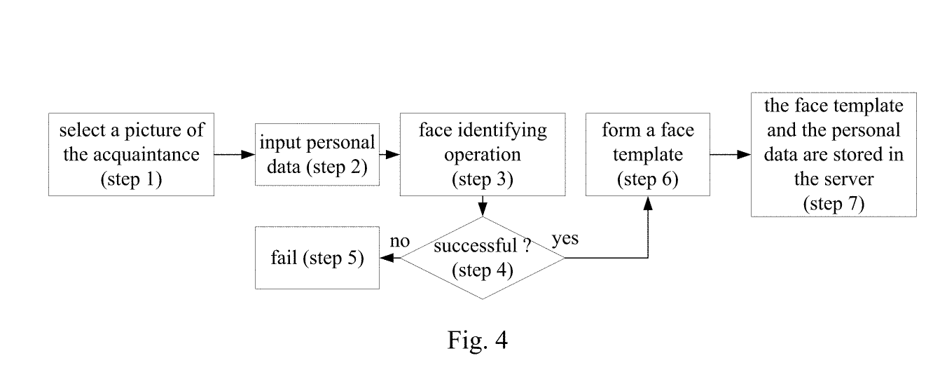

Referring to FIG. 4, there are other ways for the smart phone 5 to select a picture of the acquaintance (step 1), such as from an album of schoolmate or from facebook, and then input the personal data (such as a name) (step 2), after the four steps stated above to conduct the face identifying Operation (step 3), and then in step 4 to judge if the face identifying operation is successful? If it is not successful, then go to step 5; if it is successful, then form the face template of the user (step 6), and the face template and the personal data of the acquaintance are stored in the data base of the server 6 (step 7).

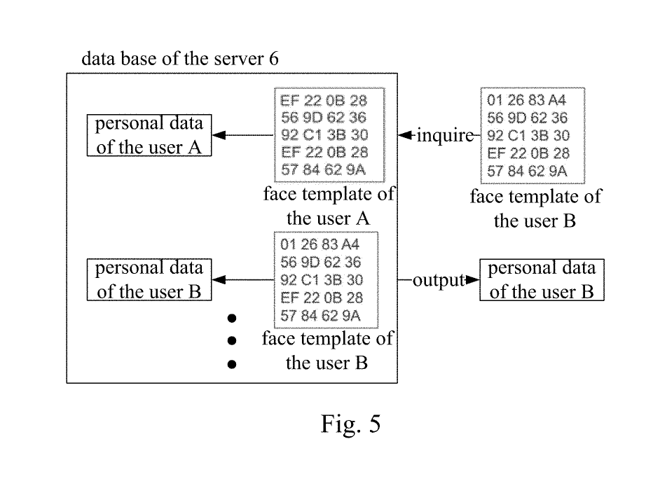

Referring to FIG. 5, the face templates in the server 6 are used for comparing with the face image of the user B. When the camera 2 captures the face image of the user B, the face template of the user B is compared with the face templates in the server 6. If the face template of the user B matches with one of the face templates in the server 6, then the user B is an acquaintance. If there is no match, then the user B is a stranger.

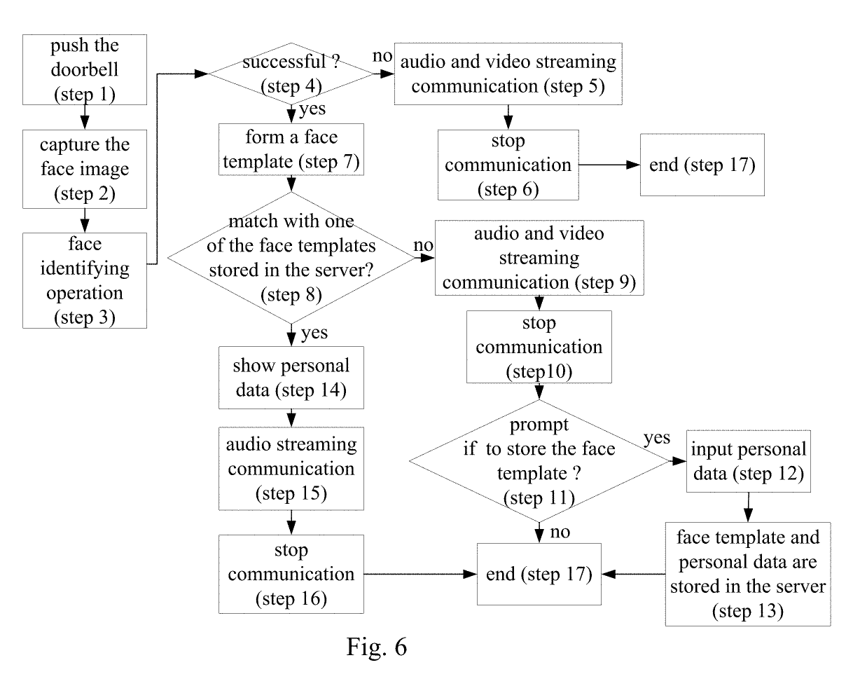

Referring to FIG. 6, which is the flow chart of the software program for the treatment method of doorbell communication according to the present invention. When the user B pushes the doorbell 1 (step 1), the camera 2 captures the face image of the user B (step 2), and then send to the server 6 for conducting face identifying operation (step 3). In step 4, judge if the face identifying operation is successful? If it is not successful, then the user B is probably wearing a respirator or a mask go to step 5 for conducting audio and video streaming communication, the person of the home uses the smart phone 5 to communicate with the user B, and decide whether to open the door or not, generally not open the door, stop the audio and video streaming communication (step 6).

In step 4, judge if the face identifying operation is successful? if it is successful, then form the face template of the user B (step 7) and compare with the face templates in the server 6 (step 8). If there is no match, then go to step 9 for the person of the home to conduct audio and video streaming communication with the user B by, the smart phone 5. In step 10, as the audio and video streaming communication is ended, prompt the person of the home whether to store the face template of the user B in the server 6 or not (step 11), if the person of the home agrees, then prompt the person of the home to input personal data of the user B (step 12), and the face template and the personal data of the user B are stored in data base of the server 6 (step 13), go to step 17 for ending. If the person of the home disagrees to store the face template of the user B, then go to step 17 for ending.

In step 8, if a face template in the data base matches with the face template of the user B, then the personal data of the matched face template in the data base are shown on the screen of the smart phone 5 (step 14), the person of the home uses the smart phone 5 for conducting audio streaming communication with the user B (step 15), without video streaming communication. As the audio streaming communication is ended (step 16), go to step 17 for ending.

The scope of the present invention depends upon the following claims, and is not limited by the above embodiments.

What is claimed is:

1. A treatment method for doorbell communication, in a structure of a doorbell communication, comprising a doorbell, a camera and a microphone, connected with a smart phone and a server of a home by a network; when a user pushes the doorbell, the camera captures a face image of the user for sending through the network to the server for conducting a face identifying operation; if the face identifying operation is not successful, then a person of a home uses the smart phone for conducting audio and video streaming communication with the user, and decide whether to open a door or not, generally not open the door, and stop the audio and video streaming communication.

2. The treatment method for doorbell communication according to claim 1, wherein if the face identifying operation is successful, then form a face template of the user and compare with face templates of acquaintances in the server; If there is no match, then the person of the home conducts audio and video streaming communication with the user by the smart phone; as the audio and video streaming communication is ended, prompt the person of the home whether to store the face template of the user in the server or not, if the person of the home agrees, then prompt the person of the home to input personal data of the user, and the face template and the personal data of the user are stored in the server; if the person of the home disagrees to store the face template of the user, then go for ending.

3. The treatment method for doorbell communication according to claim 2, wherein if a face template in the server matches with the face template of the user, then a personal data of the matched face template in the server is shown on a screen of the smart phone, the person of the home uses the smart phone for conducting audio streaming communication with the user, without video streaming communication.

4. The treatment method for doorbell communication according to claim 2, wherein face templates of acquaintances in the server can be obtained by other ways, and then input related personal data, conduct the face identifying operation; if the face identifying operation is successful, then the face template and the personal data are stored in the server.

5. The treatment method for doorbell communication according to claim 1, wherein the face identifying operation comprises four steps: capture the face image, normalization, capture characteristics of the face image and form the face template.
